(19) United States
(12) Patent Application Publication
(10) Pub. No.: US 2006/0282264 A1
(43) Pub. Date: Dec. 14, 2006

(54) Methods and systems for providing noise filtering using speech recognition

(75) Inventors: Michael S. Denny, Sharpsburg, GA (US); David J. Anderson, Lawrenceville, GA (US)

Correspondence Address: MERCHANT & GOULD BELLSOUTH CORPORATION, P.O. BOX 2903, MINNEAPOLIS, MN, 55402, US

(73) Assignee: BellSouth Intellectual Property Corporation

(21) Appl. No.: 11/148,457

(22) Filed: Jun. 9, 2005

(51) Int. Cl. G10L 15/20

(52) U.S. Cl. 704/233

(57) ABSTRACT

Systems and methods are disclosed for providing noise filtering using speech recognition. The disclosed systems and methods may include performing a speech recognition process on a signal. Furthermore, the disclosed systems and methods may include determining a first frequency range based on the performed speech recognition process, the first frequency range corresponding to an expected voice associated with the signal. In addition, the disclosed systems and methods may include attenuating a second frequency range in the signal, the second frequency range being outside the first frequency range and the extemporaneous noise in the first frequency.

### BACKGROUND OF THE INVENTION

I. Field of the Invention

The present invention generally relates to methods and systems for providing noise filtering. More particularly, the present invention relates to providing noise filtering using speech recognition.

II. Background Information

When a telephone call or verbal communication is conducted in a noisy environment, such as in a moving vehicle or in a social setting such as a bar, background noise reduces speech intelligibility and may severely affect the participants ability to conduct their conversation. Accordingly, to improve a conversation, the background noise should be reduced in a communications channel without impacting the participants' speech intelligibility.

This problem has been addressed using various conventional approaches, however, these approaches have substantial limitations. For example, while some of these conventional noise filtering/cancellation approaches have been implemented in network components such as audio conference servers supporting a telephone conference, there are limits on how much noise filtering may be achieved. These conventional approaches typically use fixed noise filters or adaptive filters (that identify the noise spectrum). In general, these conventional approaches identify the noise spectrum and then attenuate the frequency bands in which the noise exceeds the speech.

In view of the foregoing, there is a need for methods and systems for providing noise filtering more optimally. Moreover, there is a need for providing noise filtering using speech recognition.

### SUMMARY OF THE INVENTION

Consistent with embodiments of the present invention, systems and methods are disclosed for providing noise filtering.

In accordance with one embodiment, a method for providing noise filtering using speech recognition comprising performing a speech recognition process on a signal over a communications channel, determining a first frequency range based on the performed speech recognition process, the first frequency range corresponding to an expected voice associated with the signal, and attenuating a second frequency range in the signal, the second frequency range being outside the first frequency range.

According to another embodiment, a system for providing noise filtering using speech recognition comprising a memory storage for maintaining a database and a processing unit coupled to the memory storage, wherein the processing unit is operative to perform a speech recognition process on a signal, determine a first frequency range based on the performed speech recognition process, the first frequency range corresponding to an expected voice and related discourse associated with the signal, and attenuate a second frequency range in the signal, the second frequency range being outside the first frequency range, and attenuate extemporaneous signals mixed with the first frequency range.

In accordance with yet another embodiment, a computer-readable medium which stores a set of instructions which when executed performs a method for providing noise filtering using speech recognition, the method executed by the set of instructions comprising performing a speech recognition process on a signal, determining a first frequency range based on the performed speech recognition process, the first frequency range corresponding to an expected voice and related discourse associated with the signal, and attenuating a second frequency range in the signal, the second frequency range being outside the first frequency range, and attenuate the extemporaneous signals mixed with the first frequency range.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1A and FIG. 1B is a block diagram of an exemplary noise filtering system consistent with an embodiment of the present invention;

FIG. 2 is a block diagram of a noise filtering server consistent with an embodiment of the present invention; and

FIG. 3 is a flow chart of an exemplary method for providing noise filtering consistent with an embodiment of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

Systems and methods consistent with embodiments of the present invention provide noise filtering. For example, embodiments of the present invention include using speech recognition technology to provide improved noise reduction through network-hosted filtering. First, speech and associated speech frequencies are identified using speech recognition processes. Then all frequencies outside the identified speech frequencies are attenuated, as well as extemporaneous, unintelligible signals within the identified first frequency.

By providing clearer conversations in noisy situations such as moving vehicles, bars, and crowd scenes, for example, embodiments of the present invention provide a value added service that can either be activated on user request or dynamically invoked in a conversation. Moreover, embodiments of the present invention are offered, for example, as an enhanced service to businesses (e.g. coffee shops) or as a general service option available to residential or mobile users and network subscribers.

In order to enhance the noise filtering service's effectiveness, a new user may train the service to effectively recognize the new user's voice. First time enrollment/training is done, for example, by reading a predefined narrative with appropriate acoustic coverage so that the noise filtering service can effectively organize its acoustic and grammar model database to effectively find the phrases that were likely spoken by the user. After the subscription and training process is complete, the user can then use the service. Appropriate acoustic coverage may include a ‘noise free’ turn followed by ‘noisy’ turns that may leverage current technology's adaptive acoustic modeling. In another iteration, the general or global voice modeling typical in existing speaker-independent speech technology may be applied and enhanced through ongoing use.

To invoke the noise filtering service, for example, a user may be in a bar and wishes to use noise filtering to improve the quality of a call. The noise filtering service may be invoked when the user presses a specific key sequence (e.g. *23) on an end use device during the call or if the user speaks a global navigational command (e.g. “improve my call”.) Consequently, the key sequence or the global navigational command may be sent to a network switch that may then route the call to a noise filtering server.

In addition, a telecommunication network may automatically invoke the noise filtering service when noise is detected on a call. For example, a switch in the telecommunication network may test the background noise level in a call by either internal processing or by an external noise test component. When noise is detected, the call is routed to the noise filtering server for noise filtering. Embodiments of the present invention may be implemented, for example, on both a time division multiplexing (TDM) communication system and a voice-over-internet protocol (VoIP) communication system. Notwithstanding, the noise filtering server may use previously established acoustic characteristics of the user's voice (along with other global knowledge about speech—e.g. linguistics, phonetics, statistics, appropriate pattern matching) to recognize the user's speech and remove the non-conforming background noise. After this, the outbound (or inbound) speech from (or to) the user is automatically re-synthesized to replace missing segments lost, e.g. in the filtering or over the network

An embodiment consistent with the invention may comprise a system for providing noise filtering. The system comprises a memory storage for maintaining a database and a processing unit coupled to the memory storage. The processing unit is operative to perform a speech recognition process on a signal. In addition, the processing unit is operative to determine a first frequency range based on the performed speech recognition process, the first frequency range corresponding to an expected targeted voice associated with the signal. And the processing unit is operative to attenuate a second frequency range in the signal, the second frequency range being outside the first frequency range.

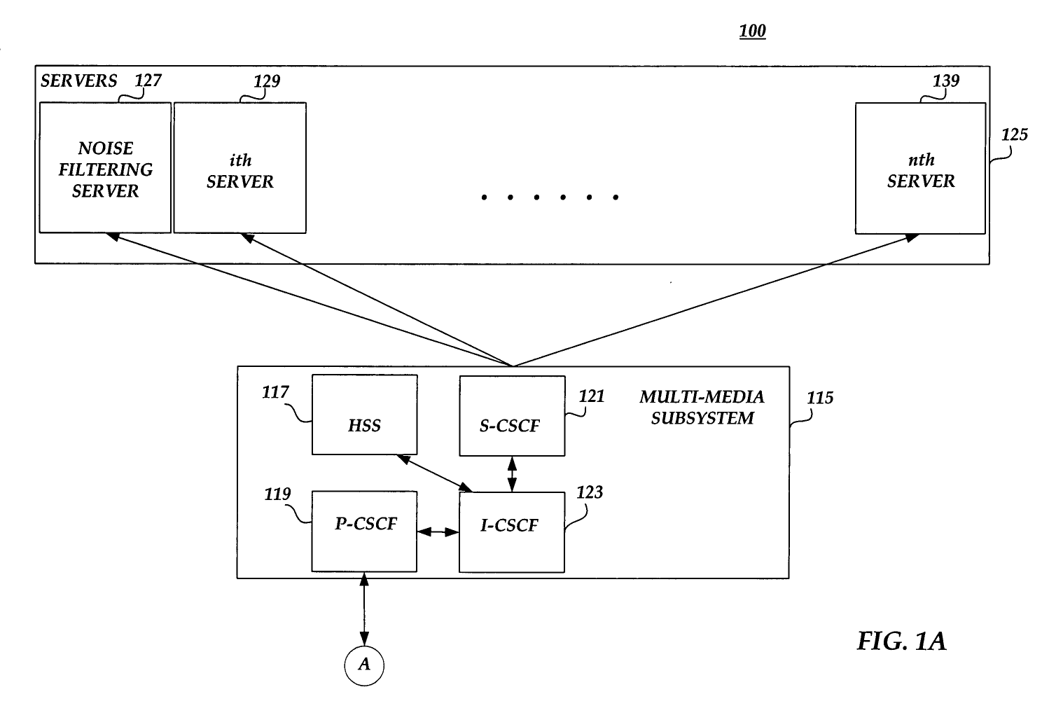

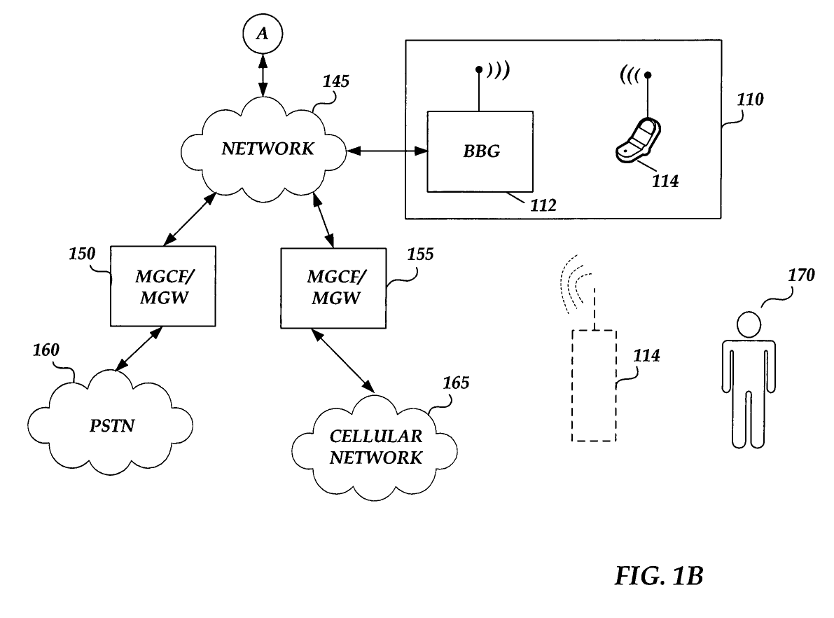

Consistent with an embodiment of the present invention, the aforementioned memory, processing unit, and other components are implemented in a noise filtering system, such as an exemplary noise filtering system 100 of FIG. 1A and FIG. 1B. Any suitable combination of hardware, software, and/or firmware may be used to implement the memory, processing unit, or other components. By way of example, the memory, processing unit, or other components are implemented within any of a plurality of servers 125, for example, a noise filtering server 127 in combination with system 100. The aforementioned system and servers are exemplary and other systems, servers, and devices may comprise the aforementioned memory, processing unit, or other components, consistent with embodiments of the present invention.

By way of a non-limiting example, FIG. 1A and FIG. 1B illustrate system 100 in which the features and principles of the present invention may be implemented. As illustrated in the block diagram of FIG. 1A and FIG. 1B, system 100 comprises an end point 110, an internet protocol multi-media subsystem (IMS) 115, plurality of servers 125, a network 145, a publicly switched telephone network (PSTN) media gateway control function/media gateway (MGCF/MGW) 150, a cellular network MGCF/MGW 155, a PSTN 160, a cellular telephone network 165, and a user 170. End point 110 comprises a broadband gateway (BBG) 112 and an end use device 114. IMS 115 comprises a home subscriber server (HSS) 117, a proxy call session control function (P-CSCF) 119, a serving call session control function (S-CSCF) 121, and an interrogating call session control function (I-CSCF) 123. Plurality of servers 125 include noise filtering server 127 and ith through nth servers 129 and 139. User 170 may be an individual, for example, desiring to use noise filtering. User 170 may also be an organization, enterprise, or any other entity having such desires.

Regarding end point 110, BBG 112 may comprise a wireless local area network interface (e.g., WLAN, IEEE 802.11), a bluetooth interface, another RF communication interface, and/or an optical interface. BBG 112 may provide a wire line or a wireless connection between end use device 114 and network 145. BBG 112 may connect to network 145, for example, through a digital subscriber line (DSL) or via a coaxial cable. The aforementioned are exemplary, and BBG 112 may connect to network 145 via other ways.

End use device 114 comprises, any device capable of accessing network 145. Furthermore, end use device 114 may comprise, any device capable of invoking a software module to perform noise filtering consistent with embodiments of the invention. For example, end use device 114 may comprise a personal computer, a cellular telephone, a cordless telephone, a session initiation protocol (SIP) telephone, a cordless (SIP) telephone. Moreover, end use device 114 may comprise a dual mode handset capable of connecting to network 145 via either BBG 112 or cellular network 165. Moreover, the end use device 114 may comprise an enhanced handset that provides a degree of noise filtering for outbound and inbound audio, in parallel with the plurality of servers 125. The aforementioned are exemplary and end use device may comprise other elements and devices.

PSTN MGCF/MGW 150 and cellular network MGCF/MGW 155 respectively provide interfaces between network 145 and PSTN 160 and cellular telephone network 165. PSTN MGCF/MGW 150 and cellular network MGCF/MGW 155 configured to receive a call from a circuit switched network (PSTN 160 and cellular telephone network 165 respectively) and translate the respective protocol to a protocol supported by network 145.

Regarding IMS 115, HSS 117 may keep the profile of user 170's service, may keep “filter criteria”, and may identify “filters” that may be engaged in a call to assist in call processing and provide services during the call. The “filter criteria” defines different application servers (e.g. any one or more of plurality of server 125) that may be engaged in the call session to provide applications and services. The services such as noise filtering, call routing, mobility management, location, video calling, ring tone applications, ringback tone applications, video tones, and call logs, for example, may operate on application servers and can be identified within the “initial filter criteria”.

I-CSCF 123 comprises a call entry point to IMS 115 from another network (such as a PSTN 160 or cellular telephone network 165 or another network's P-CSCF.) S-CSCF 121 controls the call session for end use device 114. When end use device 114 registers to IMS 115, S-CSCF 121 interrogates HSS 117 and may extract user 170's services, the “initial filter criteria”, and the addresses of the “filters” associated with user 170's services. For example, S-CSCF 121 may: i) set-up the call session with end use device 114; ii) engage any of plurality of servers 125 during the call set-up; iii) establish the call session with the answering device (or apply secondary call treatment, if required); and iv) end the call session upon a call termination message receipt. P-CSCF 119 may comprise an entry point for an IMS device into network 145. Generally, P-CSCF 119 comprises the first/last IMS network element that may communicate with an end point IMS device, for example, end use device 114.

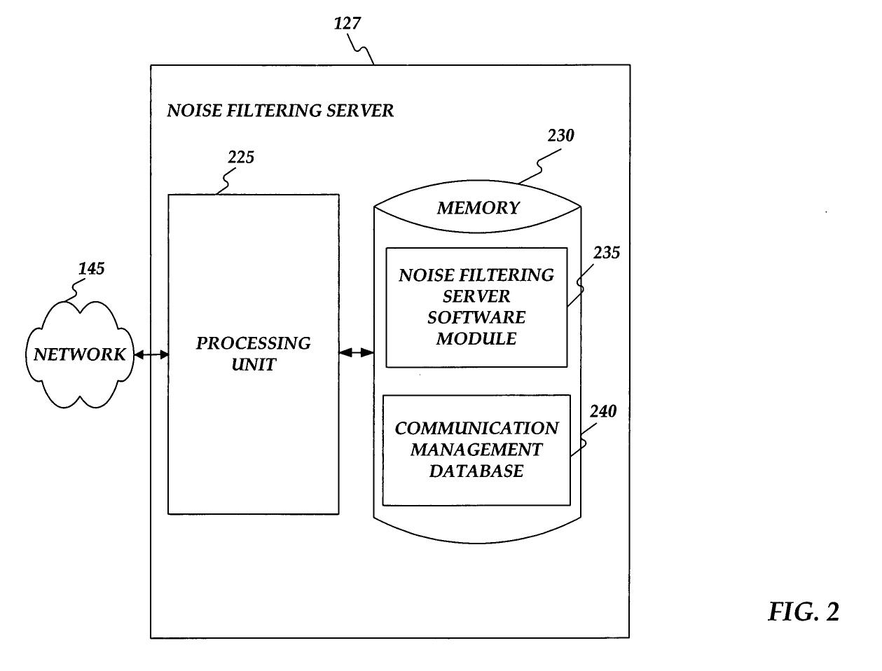

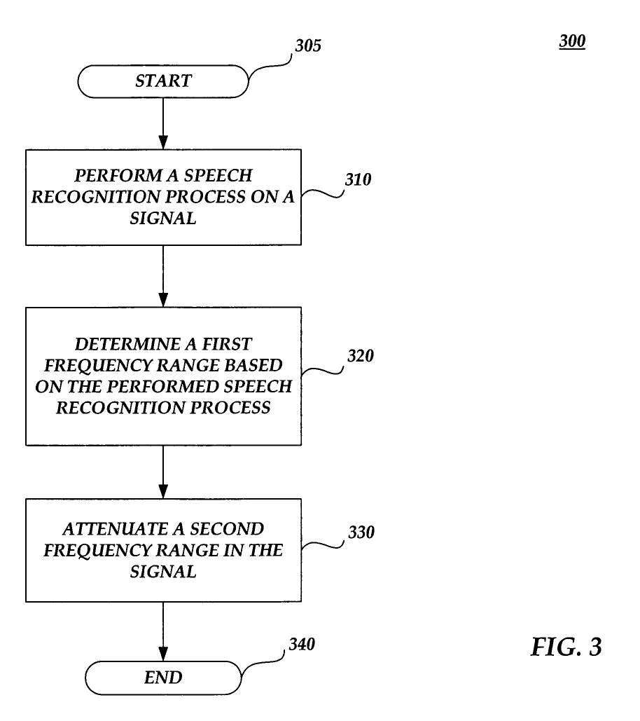

FIG. 2 shows noise filtering server 127 of FIG. 1 in more detail. As shown in FIG. 2, noise filtering server 127 includes a processing unit 225 and a memory 230. Memory 230 includes a noise filtering server software module 235 and a noise filtering database 240. While executing on processing unit 225, noise filtering software module 235 performs processes for providing noise filtering, including, for example, one or more of the stages of method 300 described below with respect to FIG. 3. Furthermore, any combination of software module 235 and database 240 may be executed on or reside in any one or more of plurality of servers 125 or end use device 114 as shown in FIG. 1.

Noise filtering server 127, any of the plurality of servers 125, or end use device 114 (“the servers”) included in system 100 may be implemented using a personal computer, network computer, mainframe, or other similar microcomputer-based workstation. The servers may though comprise any type of computer operating environment, such as hand-held devices, multiprocessor systems, microprocessor-based or programmable sender electronic devices, minicomputers, mainframe computers, and the like. The servers may also be practiced in distributed computing environments where tasks are performed by remote processing devices. Furthermore, any of the servers may comprise a mobile terminal, such as a smart phone, a cellular telephone, a cellular telephone utilizing wireless application protocol (WAP) or HTTP/HTML, personal digital assistant (PDA), intelligent pager, portable computer, a hand held computer, a conventional telephone, or a facsimile machine. The aforementioned systems and devices are exemplary and the server may comprise other systems or devices.

Network 145 may comprise, for example, a local area network (LAN) or a wide area network (WAN). Such networking environments are commonplace in offices, enterprise-wide computer networks, intranets, and the Internet. When a LAN is used as network 145, a network interface located at any of the servers may be used to interconnect any of the servers. When network 145 is implemented in a WAN networking environment, such as the Internet, the servers may typically include an internal or external modem (not shown) or other means for establishing communications over the WAN. Further, in utilizing network 145, data sent over network 145 may be encrypted to insure data security by using known encryption/decryption techniques.

In addition to utilizing a wire line communications system as network 145, a wireless communications system, or a combination of wire line and wireless may be utilized as network 145 in order to, for example, exchange web pages via the internet, exchange e-mails via the internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The servers in the wireless environment can be any mobile terminal, such as the mobile terminals described above. Wireless data may include, but is not limited to, paging, text messaging, e-mail, internet access and other specialized data applications specifically excluding or including voice transmission. For example, the servers may communicate across a wireless interface such as, for example, a cellular interface (e.g., general packet radio system (GPRS), enhanced data rates for global evolution (EDGE), a universal mobile telecommunications system (UMTS), global system for mobile communications (GSM)), a wireless local area network interface (e.g., WLAN, IEEE 802.11), a bluetooth interface, another RF communication interface, and/or an optical interface.

System 100 may also transmit data by methods and processes other than, or in combination with, network 145. These methods and processes may include, but are not limited to, transferring data via, diskette, flash memory sticks, CD ROM, facsimile, conventional mail, an interactive voice response system (IVR), or via voice over a publicly switched telephone network.

FIG. 3 is a flow chart setting forth the general stages involved in an exemplary method 300 consistent with the invention for providing noise filtering using speech recognition using system 100 of FIG. 1A and FIG. 1B. Exemplary ways to implement the stages of exemplary method 300 will be described in greater detail below. Exemplary method 300 begins at starting block 305 and proceed to stage 310 where noise filtering server 127 performs a speech recognition process on a signal.

For example, user 170 may wish to use a noise filtering service to improve the quality of a signal corresponding to a telephone call. The noise filtering service is invoked if user 170 provides a caller initiated input, for example, presses a specific key sequence (e.g. *23) on end use device 114 during the call. Furthermore, the noise filtering service may be invoked if user 170 provides a caller initiated voice command, for example, speaks a global navigational command (e.g. “improve my call”.) Consequently, once the noise filtering service is invoked, the call, in turn, is routed to noise filtering server 127.

Alternately, system 100 may automatically invoke the noise filtering service when noise is detected on a call. For example, a switch in system 100 may test the background noise level in a call by either internal processing or by an external noise test component. When noise is detected, the call may be routed to noise filtering server 127 for noise filtering.

In addition to the above, a characteristic of a calling identifier may be used to invoke the noise filtering service. For example, a calling identifier may comprise a calling telephone number identified in a calling number caller ID. In addition to a calling telephone number, the calling identifier may comprise but is not limited to, for example, other proxies for location or identification such as called number, an internet protocol (IP) address or a zip code. The aforementioned are exemplary, and the calling identifier may comprise other elements. Further, in addition to above, the system 100 may invoke the noise filtering system for one or more call channels on a shared or conferenced call.

Prior to using the noise filtering service, user 170 may train the noise filtering service to effectively recognize user 170's voice. This training may be done, for example, by user 170 reading a predefined narrative with appropriate acoustic coverage. In this way, the noise filtering service can organize user 170's acoustic and grammar model database (i.e. database 240) to effectively understand how phrases are likely spoken by user 170. After the training process is complete, user 170 can then use the service. Subsequently, noise filtering server 127 may use the previously established user 170's voice acoustic characteristics from database 240. In this way, along with other knowledge about speech (e.g. linguistics, phonetics, statistics) noise filtering server 127 may recognize user 170's speech and remove any non-conforming background noise or extemporaneous, non-conforming speech.

In performing the speech recognition process, noise filtering server 127 may use any one or more components of a directed language model or an open language model with a statistical language model and a statistical semantic model. Furthermore, in performing the speech recognition process, noise filtering server 127 may consider one or more of user 170's accent, user 170's identity, and a national region associated with user 170. The aforementioned are exemplary and noise filtering server 127 may use other models and consider attributes associated with user 170's voice.

From stage 310, where noise filtering server 127 performs the speech recognition process on the signal, exemplary method 300 advances to stage 320 where noise filtering server 127 determines a first frequency range based on the performed speech recognition process. The first frequency range may correspond to an expected voice associated with the signal. For example, noise filtering server 127, using speech recognition processes as described above, may predict words being spoken by user 170. Furthermore, knowing a frequency range associated with the predicted words, noise filtering server 127 may set the first frequency range equal to the frequency range associated with the predicted words. And within the first frequency range, the system may track the context of the words and remove noise and extemporaneous words that don't fit the tracked call's context.

Once noise filtering server 127 determines the first frequency range based on the performed speech recognition process in stage 320, exemplary method 300 continues to stage 330 where noise filtering server 127 may attenuate a second frequency range in the signal. The second frequency range may be outside the first frequency range. Accordingly, the first frequency range may stay with the signal and the second frequency range may be removed from the signal. Because the first frequency range may have a higher correlation to the voice being transmitted by the signal and the second frequency range may have a higher correlation to noise being transmitted by the signal, the quality of the call may be improved by attenuating the second frequency range. After noise filtering server 127 attenuates the second frequency range in the signal in stage 330, exemplary method 300 ends at stage 340.

Furthermore, the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described above with reference to block diagrams and/or operational illustrations of methods, systems, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A method for providing noise filtering using speech recognition, the method comprising:
performing a speech recognition process on a signal;
determining a first frequency range based on the performed speech recognition process, the first frequency range corresponding to an expected voice signal associated with the signal; and
attenuating a second frequency range in the signal containing noise and being outside the first frequency range, the second frequency range being outside the first frequency range.

2. The method of claim 1, wherein performing the speech recognition process further comprises performing the speech recognition process in response to at least one of a caller initiated input, a caller initiated voice command, a characteristic of a calling identifier, a test for noise in the signal.

3. The method of claim 1, wherein performing the speech recognition process further comprises performing the speech recognition process using at least one of a directed language model, an open language model, a statistical language model, and a statistical semantic model with related phonetic based acoustic models.

4. The method of claim 1, wherein performing the speech recognition process further comprises performing the speech recognition process that considers at least one of the environment of a caller, an accent of the caller, the identity of the caller, a national region associated with the caller, a caller initiated input, a caller initiated voice command, a characteristic a calling identifier, a test for noise in the signal.

5. The method of claim 1, wherein performing the speech recognition process further comprises performing the speech recognition process that considers data previously gather and associated with a caller's voice.

6. The method of claim 1, wherein the first frequency range and the second frequency range are in a frequency range audible by humans.

7. The method of claim 1, further comprises adding to the signal in order to improve voice information transmitted by the signal.

8. A system for providing noise filtering using speech recognition, the system comprising:
a memory storage for maintaining a database; and
a processing unit coupled to the memory storage, wherein the processing unit is operative to:
perform a speech recognition process on a signal;
determine a first frequency range based on the performed speech recognition process, the first frequency range corresponding to an expected voice signal associated with the signal; and
attenuate a second frequency range in the signal containing noise and being outside the first frequency range, the second frequency range being outside the first frequency range.

9. The system of claim 8, wherein the processing unit being operative to perform the speech recognition process further comprises the processing unit being operative to perform the speech recognition process in response to at least one of a caller initiated input, a caller initiated voice command, a characteristic a calling identifier, a test for noise in the signal.

10. The system of claim 8, wherein the processing unit being operative to perform the speech recognition process further comprises the processing unit being operative to perform the speech recognition process using at least one of a directed language model, an open language model, a statistical language model, and a statistical semantic model with related phonetic based acoustic models.

11. The system of claim 8, wherein the processing unit being operative to perform the speech recognition process further comprises the processing unit being operative to perform the speech recognition process that considers at least one of the environment of a caller, an accent of the caller, the identity of the caller, a national region associated with the caller, a caller initiated input, a caller initiated voice command, a characteristic of a calling identifier, a test for noise in the signal.

12. The system of claim 8, wherein the processing unit being operative to perform the speech recognition process further comprises the processing unit being operative to perform the speech recognition process that considers data previously gather and associated with a caller's voice.

13. The system of claim 8, wherein the first frequency range and the second frequency range are in a frequency range audible by humans.

14. A computer-readable medium which stores a set of instructions which when executed performs a method for providing noise filtering using speech recognition, the method executed by the set of instructions comprising:
performing a speech recognition process on a signal;
determining a first frequency range based on the performed speech recognition process, the first frequency range corresponding to an expected voice signal associated with the signal; and
attenuating a second frequency range in the signal containing noise and being outside the first frequency range, the second frequency range being outside the first frequency range.

15. The computer-readable medium of claim 14, wherein performing the speech recognition process further comprises performing the speech recognition process in response to at least one of a caller initiated input, a caller initiated voice command, a characteristic of a calling identifier, a test for noise in the signal.

16. The computer-readable medium of claim 14, wherein performing the speech recognition process further comprises performing the speech recognition process using at least one of a directed language model, an open language model, a statistical language model, and a statistical semantic model with related phonetic based acoustic models.

17. The computer-readable medium of claim 14, wherein performing the speech recognition process further comprises performing the speech recognition process that considers at least one of the environment of a caller, an accent of the caller, the identity of the caller, a national region associated with the caller, a caller initiated input, a caller initiated voice command, a characteristic a calling identifier, a test for noise in the signal.

18. The computer-readable medium of claim 14, wherein performing the speech recognition process further comprises performing the speech recognition process that considers data previously gather and associated with a caller's voice.

19. The computer-readable medium of claim 14, wherein the first frequency range and the second frequency range are in a frequency range audible by humans.

20. The computer-readable medium of claim 14, further comprises adding to the signal in order to improve voice information transmitted by the signal.
